(19) United States
(12) Patent Application Publication
(10) Pub. No.: US 2025/0286672 A1
(43) Pub. Date: Sep. 11, 2025

(54) SINGLE-CARRIER PACKET FOR RECEPTION BY OFDM RECEIVER

(71) Applicant: Telefonaktiebolaget LM Ericsson (publ), Stockholm (SE)

(72) Inventors: Ning HE, Sollentuna (SE); Atieh RAJABI KHAMESI, Newark, CA (US); Miguel LOPEZ, Solna (SE); Talha KHAN, Santa Clara, CA (US); Mehrnaz AFSHANG, Fremont, CA (US)

(21) Appl. No.: 18/861,381

(22) PCT Filed: May 2, 2022
(86) PCT No.: PCT/SE2022/050421

§ 371 Date: Oct. 29, 2024

(51) Int. Cl. H04L 5/00; H04L 27/26

(52) U.S. Cl. CPC H04L 5/0007; H04L 27/2678

(57) ABSTRACT

A method is disclosed of generating a single-carrier packet using packet sections with equal duration for transmission to a receiver configured to receive an OFDM signal. The method includes establishing a data portion (DATA) of the single-carrier packet, and prepending a first extension portion (EXT1) to the data portion, wherein a time interval for transmission of the first extension portion overlaps, at least partially, with a time interval for OFDM signal cyclic prefix. A method is also disclosed of processing a received signal by a receiver configured to receive an OFDM signal. The method includes applying FFT to the received signal after discarding a part of the received signal that corresponds to a length of an OFDM signal cyclic prefix, and processing a baseband representation of the received signal as a single-carrier packet. Corresponding computer program product, apparatuses, devices, packet format, and signal are also disclosed.

### TECHNICAL FIELD

The present disclosure relates generally to the field of wireless communication. More particularly, it relates to a single-carrier packet suitable for reception by an orthogonal frequency division multiplexing (OFDM) receiver.

### BACKGROUND

Many wireless communication systems employ orthogonal frequency division multiplexing (OFDM). Examples of such OFDM communication systems include fifth and sixth generation (5G, 6G) communication systems as advocated by the Third Generation Partnership Project (3GPP). In some contexts, it is desirable that devices with power consumption restrictions can operate in OFDM communication systems. However, OFDM transmission generally causes relatively high power consumption, which may be cumbersome for devices with power consumption restrictions.

Therefore, there is a need for approaches that enable operation in OFDM communication systems, without necessitating OFDM transmission.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of at least some embodiments to solve or mitigate, alleviate, or eliminate at least some of the above (or other) problems, issues, and/or disadvantages.

A first aspect is a method of generating a single-carrier packet using packet sections with equal duration for transmission to a receiver configured to receive an orthogonal frequency division multiplex (OFDM) signal. The method comprises establishing a data portion of the single-carrier packet, wherein the data portion comprises a plurality of packet sections, and prepending a first extension portion to the data portion, wherein the first extension portion comprises one or more packet sections, and wherein a time interval for transmission of the first extension portion overlaps, at least partially, with a time interval for OFDM signal cyclic prefix.

In some embodiments, the single-carrier packet is comprised in a sequence of single-carrier packets generated using packet sections with equal duration, wherein a plurality of time intervals for OFDM signal cyclic prefix occurs during transmission of the sequence of single-carrier packets, and each of the plurality of time intervals for OFDM signal cyclic prefix during transmission of the sequence of single-carrier packets is overlapped, at least partially, by a respective first extension portion of the sequence of single-carrier packets.

In some embodiments, the method further comprises determining the time interval for OFDM signal cyclic prefix.

In some embodiments, the time interval for transmission of the first extension portion comprises the time interval for OFDM signal cyclic prefix.

In some embodiments, the time interval for transmission of the first extension portion and the time interval for OFDM signal cyclic prefix are equal.

In some embodiments, the first extension portion comprises a copy of a corresponding last part of the data portion.

In some embodiments, the first extension portion comprises a reference portion with predetermined content.

In some embodiments, the method further comprises appending a second extension portion to the data portion, wherein the second extension portion is a copy of the first extension portion. In some embodiments, the first extension portion comprises a padding portion.

In some embodiments, the method further comprises indicating single-carrier packet transmission to the receiver.

In some embodiments, indicating single-carrier packet transmission comprises transmitting an explicit indication to the receiver in association with connection establishment, and/or transmitting the single-carrier packet in communication resources specifically dedicated for single-carrier transmission.

In some embodiments, where the data portion of the single-carrier packet has a fixed length and a length of the first extension portion is variable, the method further comprises selecting the length of the first extension portion based on the time interval for OFDM signal cyclic prefix to provide the, at least partial, overlap.

In some embodiments, a number of samples of each of the packet sections corresponds to an integer scaling factor multiplied by a greatest common factor (GCF) of a fast Fourier transform size of the receiver and a number of samples in an OFDM signal cyclic prefix, or to an integer factor of the GCF.

In some embodiments, the method is performed by a transmitter device with power consumption restrictions.

In some embodiments, the packet sections with equal duration specify a constant baud rate.

A second aspect is a method of processing a received signal by a receiver configured to receive an orthogonal frequency division multiplex (OFDM) signal. The method comprises applying a fast Fourier transform to the received signal after discarding a part of the received signal that corresponds to a length of an OFDM signal cyclic prefix, providing a baseband representation of the received signal based on a result of the fast Fourier transform, and processing the baseband representation of the received signal as a single-carrier packet generated using packet sections with equal duration.

In some embodiments, the method further comprises determining that the received signal comprises single-carrier packet transmission, and processing the baseband representation of the received signal as a single-carrier packet is responsive to the determination.

In some embodiments, determining that the received signal comprises single-carrier packet transmission comprises one or more of: receiving an explicit indication of single-carrier packet transmission in association with connection establishment, receiving the signal in communication resources specifically dedicated for single-carrier transmission, and detecting a reference portion in the received signal, wherein the reference portion is indicative of single-carrier packet transmission.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for generating a single-carrier packet using packet sections with equal duration for transmission to a receiver configured to receive an orthogonal frequency division multiplex (OFDM) signal. The apparatus comprises controlling circuitry configured to cause establishment of a data portion of the single-carrier packet, wherein the data portion comprises a plurality of packet sections, and prepending of a first extension portion to the data portion, wherein the first extension portion comprises one or more packet sections, and wherein a time interval for transmission of the first extension portion overlaps, at least partially, with a time interval for OFDM signal cyclic prefix.

A fifth aspect is a single-carrier transmission device comprising the apparatus of the fourth aspect.

In some embodiments, the single-carrier transmission device is a transmitter device with power consumption restrictions.

A sixth aspect is an apparatus for processing a received signal by a receiver configured to receive an orthogonal frequency division multiplex (OFDM) signal. The apparatus comprises controlling circuitry configured to cause application of a fast Fourier transform to the received signal after discarding of a part of the received signal that corresponds to a length of an OFDM signal cyclic prefix, provision of a baseband representation of the received signal based on a result of the fast Fourier transform, and processing of the baseband representation of the received signal as a single-carrier packet generated using packet sections with equal duration.

A seventh aspect is a receiver device configured to receive an orthogonal frequency division multiplex (OFDM) signal, and comprising the apparatus of the sixth aspect.

An eighth aspect is a format for transmission of a single-carrier packet using packet sections with equal duration to a receiver configured to receive an orthogonal frequency division multiplex (OFDM) signal. The format comprises a data portion of the single-carrier packet, wherein the data portion comprises a plurality of packet sections, and a first extension portion prepended to the data portion, wherein the first extension portion comprises one or more packet sections, and wherein a time interval for transmission of the first extension portion overlaps, at least partially, with a time interval for OFDM signal cyclic prefix.

A ninth aspect is a signal using packet sections with equal duration for carrying a single-carrier packet to a receiver configured to receive an orthogonal frequency division multiplex (OFDM) signal, wherein the single-carrier packet comprises a data portion, wherein the data portion comprises a plurality of packet sections, and a first extension portion prepended to the data portion, wherein the first extension portion comprises one or more packet sections, and wherein a time interval for transmission of the first extension portion overlaps, at least partially, with a time interval for OFDM signal cyclic prefix.

In some embodiments, any of the above aspects may additionally have features identical with or corresponding to any of the various features as explained above for any of the other aspects.

An advantage of some embodiments is that approaches are provided that enable operation in OFDM communication systems, without necessitating OFDM transmission.

An advantage of some embodiments is that devices with power consumption restrictions can operate in OFDM communication systems.

Generally, devices with power consumption restrictions include, for example, communication devices powered by a non-chargeable power source, communication devices powered by energy harvesting, and ultra-low power devices.

Also generally, it should be noted that embodiments may be equally applicable for devices with less limiting power consumption restrictions (e.g., devices powered by re-chargeable battery, devices connected to the power grid, etc.).

For example, a device with power consumption restrictions may be defined as a communication device with stricter power consumption restrictions than devices powered by re-chargeable battery and/or than devices connected to the power grid.

An advantage of some embodiments is that some portions of an OFDM receiver may be used for reception as if the received signal was an OFDM signal.

Particularly, an advantage of some embodiments is that no, or relatively little, data is lost when portions of an OFDM receiver are used for reception as if the received signal was an OFDM signal (e.g., performing cyclic prefix removal).

The latter is particularly beneficial for when the transmitter is a device with power consumption restrictions, because the link budget of such devices is often limited in the uplink and any loss of data in the reception may decrease the coverage.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic block diagram illustrating example processing by an OFDM transmitter;

FIG. 2 is a schematic drawing illustrating an example format for an OFDM symbol;

FIG. 3 is a schematic block diagram illustrating example processing by an OFDM receiver;

FIG. 4 is a flowchart illustrating example method steps according to some embodiments;

FIG. 5 is a flowchart illustrating example method steps according to some embodiments;

FIG. 6 is a signaling diagram illustrating example signaling according to some embodiments;

FIG. 7A is a schematic drawing illustrating a collection of example single-carrier packets according to some embodiments;

FIG. 7B is a schematic drawing illustrating an example single-carrier packet according to some embodiments;

FIG. 7C is a schematic drawing illustrating a collection of example single-carrier packets according to some embodiments;

FIG. 7D is a schematic drawing illustrating an example sequence of single-carrier packets according to some embodiments;

FIG. 8 is a schematic block diagram illustrating an example apparatus according to some embodiments;

FIG. 9 is a schematic block diagram illustrating an example apparatus according to some embodiments; and

FIG. 10 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, approaches will be described and exemplified that enable operation in OFDM communication systems, without necessitating OFDM transmission. The approaches may be particularly suitable for enabling devices with power consumption restrictions to operate in OFDM communication systems, but it should be noted that embodiments may be equally applicable for devices with less limiting power consumption restrictions.

Generally, it should be noted that even though the description and exemplification herein illustratively refers to OFDM communication systems and receivers configured to receive an OFDM signal, the principles of the various embodiments may be equally applicable to communication systems and receivers for non-OFDM multicarrier signals with portions similar to the cyclic prefix. Thus, all instances of OFDM as mentioned herein may (as suitable) be replaced by the more general term multicarrier.

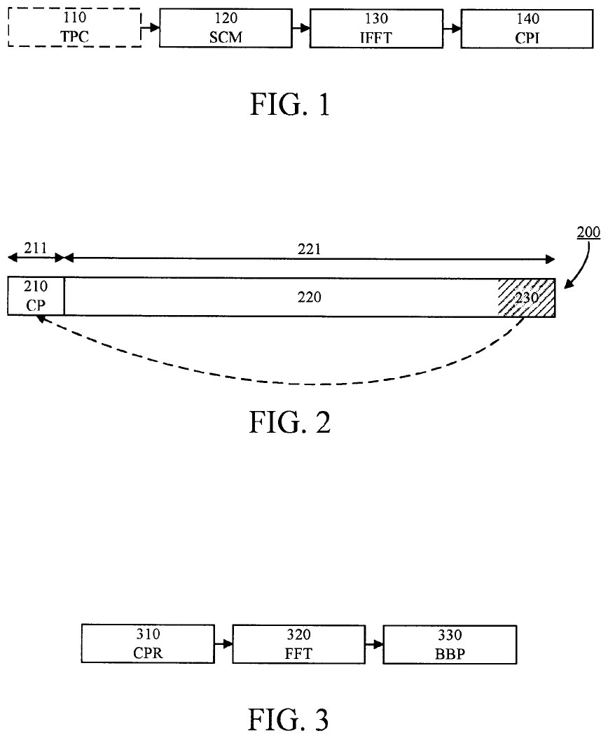

An example OFDM communication system scenario, where some embodiments may be beneficial, will now be described with reference to FIGS. 1, 2, and 3. The example scenario relates to new radio (NR) as advocated by 3GPP for 5G and 6G.

The downlink (DL) transmission waveform in NR is conventional OFDM using a cyclic prefix (CP), and the uplink (UL) transmission waveform in NR can also be conventional OFDM using a CP. Optionally, the UL transmission may apply a transform precoding function performing DFT spreading (DFT-s-OFDM). For example, the implementation may allow the transform precoding function to be dynamically disabled or enabled.

Downlink and uplink transmissions may typically (e.g., in NR) be organized into frames with 10 ms duration, wherein each frame consists of ten subframes with 1 ms duration, and is divided into two equally sized half-frames consisting of five subframes each. The slot duration may be 14 symbols with Normal CP and 12 symbols with Extended CP. Furthermore, the slot duration may vary over time as a function of the used sub-carrier spacing; e.g., so that there is always an integer number of slots in a subframe.

FIG. 1 schematically illustrates example processing by an OFDM transmitter for NR. The example processing includes sub-carrier mapping (SCM) 120, application of inverse fast Fourier transform (IFFT) 130, and CP insertion (CPI) 140. For UL transmission, the example processing optionally also includes transform precoding (TPC) 110 preceding the sub-carrier mapping.

The CP provides a guard interval to reduce inter-symbol interference between OFDM symbols; thereby improving link reliability in multipath environments. Generally, the CP of an OFDM symbol is created by replicating samples from the end of the OFDM symbol at the start of the OFDM symbol. Thereby, the linear convolution caused by a frequency-selective multipath channel can be modeled as a circular convolution, and can be transformed to the frequency domain via a discrete Fourier transform (DFT). The CP typically also simplifies channel estimation and equalization.

FIG. 2 illustrates an example format for an OFDM symbol 200, depicted in the time domain. The OFDM symbol 200 has a CP 210 (with duration T_{CP} 211), which is prepended to the data portion 220 (with duration 221) of the OFDM symbol, which carries the time domain samples of the OFDM symbol. As already mentioned, the CP 210 of the OFDM symbol 200 is created as a copy of the end part 230 of the data portion 220.

Multiple numerologies and flexible channel bandwidth are supported in NR. A numerology is defined by sub-carrier spacing (SCS) and CP overhead. Multiple SCSs can be derived by scaling a basic SCS by an integer 2^{μ}. The numerology can be selected independently of the frequency band. However, relatively small SCSs are typically not used for relatively high carrier frequencies. Transmission numerologies currently supported for NR are summarized in the following table.

| | | | Supported | Supported |
|---|---|---|---|---|
| μ | Δf = 2^{μ} · 15[kHz] | Cyclic prefix | for data | for synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

The flexible OFDM numerology makes NR suitable for a wide range of frequencies and deployment scenarios. As exemplified above, the SCS is typically scalable by 15 [KHz]×2^{μ}, where μ∈{0, 1, 2, . . . }, and the slot length (and correspondingly the symbol duration) typically decreases with increasing SCS. In NR as currently specified, each slot where normal CP is applied consists of 14 OFDM symbols and each subframe has a duration of 1 ms. Thus, the number of slots within a subframe is typically a function of the SCS.

The CP length 211 may be determined as N_{CP,l}^{μ}T_{c} based on the following formula, which expresses the number of samples in the CP (see 3GPP technical specification (TS) 38.211, sections 4.1 and 5.3):

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {2}^{- μ} & normal cyclic prefix , l \neq 0 and l \neq 7 \cdot {2}^{μ}\end{matrix}$$

where κ=Tₛ/T_{c}=64 is a constant, a subframe duration is 1 ms, and l is an OFDM symbol index counting from 0 to the number of OFDM symbols per subframe minus one. The basic time unit for NR is denoted by T_{c}=1/(Δfₘₐₓ·N_{f}), where the maximum SCS currently defined in NR is Δfₘₐₓ=480·10³ Hz, and N_{f}=4096. The basic time unit in 3GPP long term evolution (LTE) systems is denoted by Tₛ=1/(Δf_{ref}·N_{f,ref}), where Δf_{ref}=15·10³ Hz, and N_{f,ref}=2048.

The symbol duration without CP 221 may be determined as Nᵤ^{μ}T_{c}, where the number of samples in an OFDM symbol without CP is given by Nᵤ^{μ}=2048κ·2^{-μ}.

Generally, a receiver for a digital communications system comprises an antenna system, an analog front-end, and a digital front-end for conversion of the analog radio signal to a digital baseband signal for further processing (e.g., equalization and decoding). In relation to OFDM-based communication systems such as 3GPP 5G systems, some receiver implementations speed up the processing by utilizing hardware accelerators (e.g., for fast Fourier transform, FFT, that transforms time domain samples to frequency domain). Such accelerators may perform cyclic prefix removal before application of the FFT.

In many scenarios, the cyclic prefix removal removes a piece at the beginning of the OFDM symbol and a piece at the end of the OFDM symbol, wherein the two pieces together correspond to the length of the cyclic prefix. Due to the construction of the CP illustrated in

FIG. 2, such removal does not negatively impact the decoding of the OFDM symbol.

Generally, cyclic prefix removal may be performed according to any suitable approach (e.g., as known in the prior art). Typically, the receiver has knowledge regarding the approximate starting point of each OFDM symbol (e.g., with an error which is smaller than the length of the CP). This can be achieved by transmission synchronization.

FIG. 3 schematically illustrates example processing by an OFDM receiver. The example processing includes cyclic prefix removal (CPR) 310, application of fast Fourier transform (FFT) 320, and baseband processing (BBP) 330.

Generally, cyclic prefix removal refers to the process of discarding a part of the received signal corresponding to the length of an OFDM signal cyclic prefix.

As already mentioned, devices with power consumption restrictions (e.g., ultra-low power devices) may not be suitable for transmission of OFDM waveforms since OFDM transmission generally causes relatively high power consumption. Hence, it is typically preferable to transmit some other type of signal from devices with power consumption restrictions; e.g., single-carrier constant envelope waveforms, which are less complex to generate than OFDM waveforms (e.g., IFFT is not needed), and entail higher power amplifier (PA) efficiency and lower power consumption than OFDM transmission.

However, reception of such signals by an OFDM receiver may be problematic, which is an obstacle when devices with power consumption restrictions are to operate in OFDM communication systems. For example, information may be lost when cyclic prefix removal is applied for reception of non-OFDM signals.

On the other hand, it would be beneficial if non-OFDM signals could be implemented by reusing at least some of the receiver architecture (e.g., hardware accelerators) optimized for high data rate services and OFDM-based physical layers. For example, it is preferable that 5G base stations are enabled to receive non-OFDM signals by means of software upgrades; without requiring any change of hardware or systemization.

As will be exemplified in the following, some embodiments provide solutions to this problem by prepending a first extension portion when a single-carrier packet is generated, wherein a time interval for transmission of the first extension portion overlaps, at least partially, with a time interval for an OFDM signal cyclic prefix. For example, the content of the first extension portion can be redundant, or otherwise dispensable, information. Thereby, cyclic prefix removal becomes less damaging compared to single-carrier transmission without the first extension portion because no, or at least less, information is lost in the cyclic prefix removal for some embodiments.

Generally, a single-carrier signal (comprising single-carrier packet(s)) may be generated by modulating phase and/or amplitude of one carrier, as opposed to a multicarrier signal where data is used to modulate phases and/or amplitudes of two or more carriers (e.g., subcarriers).

To simplify the signal generation at the transmitter, some embodiments suggest that a constant baud rate is used, which restricts signal generation to using packet sections with equal duration. The constant baud rate may be seen as associated with a packet section grid in the time domain, wherein the density of the grid corresponds to the baud rate (and, consequently, to the packet section duration), and wherein each grid spacing specifies the timing of a corresponding packet section.

Using a constant baud rate (and thereby packet sections with equal duration) may be beneficial because signal generation and/or receiver processing may be simplified compared to using a variable baud rate.

For example, mathematical expressions for signals which are linearly modulated or frequency/phase modulated (and which can typically be generated and processed very efficiently with simple logic and simple signal processing) typically assume that the baud rate is constant. Using a variable baud rate would typically require more complex logic and signal processing (e.g., because the modulation process would depend on time as well as on the data). Alternatively or additionally, using a variable baud rate would typically require multiple filters to keep the signal bandwidth stable.

An obstacle encountered in in relation to using a constant baud rate (and thereby packet sections with equal duration) is that the CP duration may differ between different OFDM symbol occasions. Furthermore, the interval between CP occasions may vary (since the OFDM symbol duration may vary).

In a typical example, the interval between CP occasions is 66.66 μs and the CP duration varies between the two possible values of 4.96 μs (short CP) and 5.20 μs (long CP). NR features an repetitive OFDM signal structure where one long CP is followed by six short CPs.

Some embodiments offer solutions to this obstacle by dynamically determining the length and timing of the first extension portion in relation to the equal-duration packet sections.

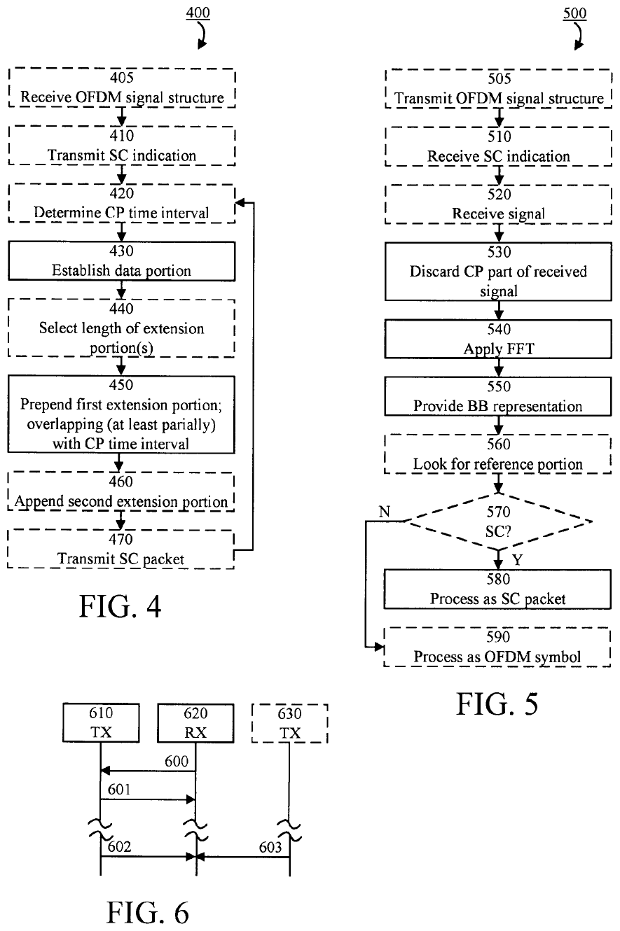

FIG. 4 illustrates an example method 400 according to some embodiments. The method 400 is a method of generating a single-carrier (SC) packet for transmission to a receiver configured to receive an orthogonal frequency division multiplex (OFDM) signal.

Typically, the method 400 may be performed by a transmitter device. For example, the method 400 may be performed by a transmitter device with power consumption restrictions (e.g., a communication device powered by a non-chargeable power source, a communication device powered by energy harvesting, an ultra-low power device, etc.).

The single-carrier packet is generated using packet sections with equal duration (e.g., specifying a constant baud rate). The single-carrier packet may have a duration which is shorter than, equal to, or longer than an OFDM symbol of the OFDM signal. Alternatively or additionally, the start of the time interval for transmission of the single-carrier packet may precede, coincide with, or succeed the start of an OFDM symbol of the OFDM signal.

The method 400 comprises establishing a data portion of the single-carrier packet, as illustrated by step 430, wherein the data portion comprises (e.g., consists of) a plurality of packet sections.

The cardinality (i.e., the size) of the plurality may be fixed, or may be variable between different single-carrier packets. In some embodiments, the cardinality of the plurality may be determined based on the interval between consecutive CP occasions and/or the CP timing. For example, the cardinality of the plurality may be determined as the highest cardinality for which the plurality of equal-duration packet sections has an accumulated duration that is shorter than, or equal to, the duration of the interval between consecutive CP occasions. Alternatively or additionally, the cardinality of the plurality may be determined as the highest cardinality for which the plurality of equal-duration packet sections, in the context of a packet section grid and the CP timing, has no overlap with any CP.

The method 400 also comprises prepending a first extension portion to the data portion, as illustrated by step 450, wherein the first extension portion comprises (e.g., consists of) one or more packet sections. An advantage with prepending a first extension portion is that no data is lost if cyclic prefix removal removes a piece at the beginning of the single-carrier packet.

Generally, prepending a first extension portion to a data portion may refer to concatenating the first extension portion and the data portion such that the data portion follows directly after the first extension portion. Alternatively or additionally, the term “prepending” may be interpreted in accordance with IEEE specifications for OFDM signalling that relate to the physical layer (PHY).

In some embodiments, the method 400 may further comprise appending a second extension portion to the data portion, as illustrated by optional step 460. The second extension portion may, for example, comprise (e.g., consist of) one or more packet sections. An advantage with appending a second extension portion is that no data is lost if cyclic prefix removal removes a piece at the end of the single-carrier packet.

Generally, appending a second extension portion to a data portion may refer to concatenating the second extension portion and the data portion such that the data portion is directly followed by the second extension portion.

According to some embodiments, the method 400 further comprises selecting the length of the first extension portion (and/or the length of the second extension portion; when applicable), as illustrated by optional step 440.

The number of packet sections of the first extension portion may be fixed, or may be variable between different single-carrier packets. In some embodiments, the number of packet sections of the first extension portion may be determined based on the CP duration and/or the CP timing. For example, the number of packet sections of the first extension portion may be determined as the smallest number for which the one or more equal-duration packet sections has an accumulated duration that is longer than, or equal to, the CP duration. Alternatively or additionally, the number of packet sections of the first extension portion may be determined as the smallest number for which the one or more equal-duration packet sections, in the context of a packet section grid and the CP timing, completely overlap a CP. Yet alternatively or additionally, the number of packet sections of the first extension portion may be restricted to be at most two.

More generally, a time interval for transmission of the first extension portion overlaps, at least partially, with a time interval for OFDM signal cyclic prefix. To this end, step 440 may comprise selecting the length of the first extension portion based on the time interval for OFDM signal cyclic prefix to provide the, at least partial, overlap.

The number of packet sections of the second extension portion may be fixed, or may be variable between different single-carrier packets. In some embodiments, the number of packet sections of the second extension portion may be determined based on the CP duration and/or the number of packet sections of the first extension portion. For example, the number of packet sections of the second extension portion may be determined as the smallest number for which the one or more equal-duration packet sections has an accumulated duration that is longer than, or equal to, the CP duration. Alternatively or additionally, the number of packet sections of the second extension portion may be determined as the number of packet sections of the first extension portion. Yet alternatively or additionally, the number of packet sections of the second extension portion may be restricted to be at most one, or at most two.

In a particular example, the data portion of the single-carrier packet has a fixed length and the length of the first extension portion (and/or of the second extension portion; when applicable) is variable. Then, step 440 may comprise selecting the length of the first extension portion (and/or of the second extension portion; when applicable) to provide the, at least partial, overlap between the first extension portion and the time interval for OFDM signal cyclic prefix; e.g., for the current single-carrier packet as well as for the subsequent single-carrier packet. Thus, when the data portion of the single-carrier packet has a fixed length, a variable length of the first and/or second extension portions may be used to accommodate each fixed length data portion within a OFDM signal structure with (potentially varying) time intervals for OFDM signal cyclic prefix.

In some embodiments, the time interval for transmission of the first extension portion comprises the time interval for OFDM signal cyclic prefix. For example, the time interval for transmission of the first extension portion and the time interval for OFDM signal cyclic prefix may be equal, or the time interval for transmission of the first extension portion may extend beyond the time interval for OFDM signal cyclic prefix at one or both ends of the time interval for OFDM signal cyclic prefix. These embodiments can provide for that no information is lost by cyclic prefix removal.

In some embodiments, the time interval for transmission of the first extension portion only partially comprises the time interval for OFDM signal cyclic prefix. For example, the time interval for transmission of the first extension portion may be comprised in the time interval for OFDM signal cyclic prefix such that the time interval for OFDM signal cyclic prefix extends beyond the time interval for transmission of the first extension portion at one or both ends of the time interval for OFDM signal cyclic prefix, or the time interval for transmission of the first extension portion may extend beyond the time interval for OFDM signal cyclic prefix at one end of the time interval for OFDM signal cyclic prefix while the time interval for OFDM signal cyclic prefix extends beyond the time interval for transmission of the first extension portion at the other end of the time interval for OFDM signal cyclic prefix. These embodiments can provide for that less information is lost by cyclic prefix removal than if the first extension portion was not used.

Typically, the single-carrier packet is comprised in a sequence of single-carrier packets generated using packet sections with equal duration, wherein a plurality of time intervals for OFDM signal cyclic prefix occurs during transmission of the sequence of single-carrier packets. Then, each of the plurality of time intervals for OFDM signal cyclic prefix during transmission of the sequence of single-carrier packets is typically overlapped (at least partially) by a respective first extension portion of the sequence of single-carrier packets. Thereby, each cyclic prefix removal by the receiver of the sequence of single-carrier packets relates to a respective first extension portion, and causes less information loss than if the first extension portions were not used.

In some embodiments, the method 400 comprises determining the time interval for OFDM signal cyclic prefix, as illustrated by optional step 420.

For example, a transmitter device performing the method 400 may have a priori knowledge of the time interval for OFDM signal cyclic prefix (e.g., based on an OFDM signal structure specified by standardization). A priori knowledge of the time interval for OFDM signal cyclic prefix may be hardcoded in the transmitter device.

Alternatively or additionally, information regarding the time interval for OFDM signal cyclic prefix may be provided to the transmitter device by the OFDM receiver or by another node, which may be useful—for example—when the CP duration is dynamically variable (e.g., by a communication network to which the receiver belongs). For example, the method 400 may comprise receiving information specifying an OFDM signal structure (including time intervals for OFDM signal cyclic prefix), as illustrated by optional step 405, and step 420 may comprise determining the time interval for OFDM signal cyclic prefix based on the OFDM signal structure.

In some particularly relevant examples, the OFDM signal structure comprises a periodic pattern of CP durations. For example, NR includes a pattern where every seventh OFDM symbol has a CP which is longer than the CP of the other OFDM symbols (i.e., the pattern specifies that one OFDM symbol with a relatively long CP is followed by six OFDM symbols with relatively short CPs, which is in turn followed by one OFDM symbol with a relatively long CP, and so on.

The number of packet sections of the second extension portion may be fixed, or may be variable between different single-carrier packets. In some embodiments, the number of packet sections of the second extension portion may be determined based on the number of packet sections of the first extension portion. For example, the number of packet sections of the second extension portion may be equal to, or less than, the number of packet sections of the first extension portion. Alternatively or additionally, the number of packet sections of the second extension portion may be restricted to be at most one, or at most two.

The first extension portion may comprise (e.g., consist of) a copy of a corresponding last part of the data portion (in similarity with the CP of an OFDM symbol). Advantages of this approach correspond to advantages of the CP as used for an OFDM symbol. For example, simplified transform to frequency domain may be achieved due to circular convolution modeling.

Alternatively or additionally, no data is lost even if cyclic prefix removal removes a piece at the beginning of the single-carrier packet and a piece at the end of the single-carrier packet (at least when the first extension portion is not shorter than the CP duration).

Alternatively or additionally, the first extension portion may comprise (e.g., consist of) a reference portion with predetermined content (e.g., a pilot sequence). An advantage of this approach is that parts of the reference portion that remain after cyclic prefix removal may be used for phase tracking, and/or frequency tracking, and/or synchronization by the receiver (e.g., by correlation to the predetermined content).

Yet alternatively or additionally, the first extension portion may comprise (e.g., consist of) a padding portion. The content of the padding portion may be any dummy content. For example, the padding portion may be an all-zero portion, an all-one portion, a random-content portion, or similar. An advantage of this approach is that parts of the padding portion that remain after cyclic prefix removal may—if its content is known—be used as a priori information for the receiver (e.g., to improve decoder performance).

In some embodiments, the second extension portion comprises (e.g., consists of) a copy of the first extension portion, or a copy of part of the first extension portion. This may be particularly relevant when the first extension portion comprises a reference portion with predetermined content.

When the second extension portion consists of a copy of (at least the first part of) the first extension portion, similar advantages may be achieved as for the CP used for an OFDM symbol. For example, simplified transform to frequency domain may be achieved due to circular convolution modeling. Alternatively or additionally, no data is lost even if cyclic prefix removal removes a piece at the beginning of the single-carrier packet and a piece at the end of the single-carrier packet (at least when the first extension portion is not shorter than the CP duration).

Alternatively or additionally, the second extension portion may comprise content different from that of the first extension portion. For example, the second extension portion may comprise (e.g., consist of) a reference portion with predetermined content and/or a padding portion even if the first extension portion does not.

The method 400 typically also comprises transmitting the single-carrier packet to the receiver, as illustrated by optional step 470. Alternatively (e.g., if the method 400 is not performed by the transmitter device), the method 400 may comprise causing transmission of the single-carrier packet to the receiver. In either case, suitable parts of the method 400 may be repeated for each single-carrier packet in a sequence of single-carrier packets, as illustrated by the loop back from step 470 to step 420.

In some embodiments, the method 400 comprises indicating single-carrier (SC) packet transmission to the receiver. Indicating SC packet transmission may, for example, comprise transmitting (or causing transmission of) an explicit indication to the receiver (e.g., in association with connection establishment; note that one bit is sufficient for this indication), as illustrated by optional step 410. Alternatively or additionally, indicating SC packet transmission may comprise transmitting (or causing transmission of) the single-carrier packet in step 470 in communication resources (e.g., time/frequency resources) specifically dedicated for single-carrier transmission.

FIG. 5 illustrates an example method 500 according to some embodiments. The method 500 is a method of processing a received signal by a receiver configured to receive an orthogonal frequency division multiplex (OFDM) signal. In some embodiments, the method 500 may comprise receiving the signal, as illustrated by optional step 520 (compare with corresponding transmission step 470 of FIG. 4).

For example, the received signal may comprise single-carrier packet(s) generated using packet sections with equal duration (compare with the single-carrier packet generation of the method 400, described with reference to FIG. 4). Thus, the received signal may comprise a single-carrier packet generated by establishment of a data portion comprising a plurality of packet sections (compare with step 430 of FIG. 4), and prepending of a first extension portion to the data portion (compare with step 450 of FIG. 4), wherein the first extension portion comprises one or more packet sections, and wherein a time interval for transmission of the first extension portion overlaps, at least partially, with a time interval for OFDM signal cyclic prefix.

Typically, the receiver is an OFDM receiver that blindly discards a part of the received signal corresponding to the length of an OFDM signal cyclic prefix. For example, the receiver may be an OFDM receiver wherein the initial processing of the received signal is performed as if the received signal is an OFDM signal (e.g., due to that the initial processing is not aware of the format of the received signal).

Generally, the initial processing may comprise some, or all, of the radio frequency processing of a received signal. For example, the initial processing may include at least processing up to FFT. It should be noted that other embodiments enable a received signal comprising single-carrier packet(s) to be processed by a receiver which is configured to receive an OFDM signal, but which does not blindly discard a part of the received signal corresponding to the length of an OFDM signal cyclic prefix. For example, the receiver may be an OFDM receiver wherein the initial processing of the received signal is performed differently depending on whether the received signal is an OFDM signal or a signal comprising single-carrier packet(s) (i.e., the initial processing has at least some awareness of the format of the received signal).

The method 500 comprises discarding a part of the received signal that corresponds to the length of an OFDM signal cyclic prefix (i.e., a CP part), as illustrated by step 530, and thereafter applying a fast Fourier transform (FFT) to the received signal, as illustrated by step 540. The method 500 also comprises providing a baseband (BB) representation of the received signal based on a result of the fast Fourier transform, as illustrated by step 550.

When the received signal comprises single-carrier packet(s), the method 500 comprises processing the baseband representation of the received signal as a single-carrier (SC) packet generated using packet sections with equal duration, as illustrated by step 580. In some embodiments, step 580 may comprise converting the frequency domain samples to the time domain for demodulation. In some embodiments, step 580 may comprise processing the SC packet in the frequency domain.

When the received signal comprises OFDM symbols, the method 500 may comprise processing the baseband representation of the received signal as an OFDM symbol, as illustrated by optional step 590.

Processing the baseband representation of the received signal as a single-carrier packet or as an OFDM symbol may include any suitable processing. For example, similar processing may be used as for situations where single-carrier packet transmission and OFDM symbol transmission are multiplexed in the frequency domain.

In some embodiments, the method 500 further comprises determining whether or not the received signal comprises single-carrier (SC) packet transmission, as illustrated by optional step 570.

When it is determined that the received signal comprises single-carrier packet transmission, processing the baseband representation of the received signal as a single-carrier packet in step 580 may be responsive to the determination. This alternative is represented by the Y-path out of step 570.

When it is determined that the received signal comprises only OFDM symbol transmission, i.e., that the received signal does not comprise single-carrier packet transmission, processing the baseband representation of the received signal as an OFDM symbol in step 590 may be responsive to the determination. This alternative is represented by the N-path out of step 570. Determining that the received signal comprises single-carrier packet transmission may be performed in any suitable way.

For example, determining that the received signal comprises single-carrier packet transmission may comprise receiving (e.g., from the transmitter of the received signal) an explicit indication of single-carrier packet transmission in association with connection establishment, as illustrated by optional step 510 (compare with step 410 of FIG. 4).

Alternatively or additionally, determining that the received signal comprises single-carrier packet transmission may comprise receiving the signal according to step 520 in communication resources specifically dedicated for single-carrier transmission.

Yet alternatively or additionally, determining that the received signal comprises single-carrier packet transmission may comprise detecting a reference portion in the received signal, wherein the reference portion is indicative of single-carrier packet transmission. To this end, the method 500 may comprise a step of looking for reference portion(s) in the received signal, as illustrated by optional step 560. For example, step 560 may comprise performing correlation between the received signal-or portion(s) thereof (e.g., portion(s) corresponding to the first and/or second extension portion of a potential single-carrier packet)-with a known reference sequence (e.g., a pilot sequence). It may be determined that the received signal comprises single-carrier packet transmission when the correlation value exceeds a corresponding threshold value. Alternatively or additionally, it may be determined that the received signal does not comprise single-carrier packet transmission when the correlation value does not exceed the corresponding threshold value.

In some embodiments, the received signal may comprise a superposition of single-carrier packet transmission and OFDM symbol transmission.

Then, the Y-path out of step 570 (corresponding to a determination that the received signal comprises single-carrier packet transmission) may entail determining whether or not the received signal also comprises OFDM symbol transmission.

When it is determined that the received signal comprises only single-carrier packet transmission, step 580 may be executed alone.

When it is determined that the received signal comprises single-carrier packet transmission and OFDM symbol transmission in superposition, step 580 may be executed for the single-carrier packet transmission fraction of the received signal, and step 590 may be executed for the OFDM symbol transmission fraction of the received signal.

In some embodiments, the method 500 comprises providing (e.g., transmitting) information regarding the time interval for OFDM signal cyclic prefix (e.g., by providing an OFDM signal structure) to the transmitter device, as illustrated by optional step 505 (compare with step 405 of FIG. 4).

FIG. 6 schematically illustrates example signaling according to some embodiments, between a transmitter device 610 (TX; e.g., performing the method 400 of FIG. 4) and a receiver 620 (RX; e.g., performing the method 500 of FIG. 5).

The receiver 620 is configured to receive an OFDM signal (e.g., the OFDM signal 603 from OFDM transmitter device 630). Furthermore, the receiver 620 may provide information regarding the time interval for OFDM signal cyclic prefix to the transmitter device 610, as illustrated by the signal 600 (compare with step 505 of FIG. 5 and step 405 of FIG. 4).Alternatively or additionally, the transmitter device 610 may transmit an explicit indication of single-carrier packet transmission to the receiver 620, as illustrated by the signal 601 (compare with step 410 of FIG. 4 and step 510 of FIG. 5).

It should be noted that the arrangement illustrated in FIG. 6 for the signals 600 and 601 is merely an illustrative example.

In some embodiments, the signal 601 precedes the signal 600 (which may be beneficial because the transmission of the signal 600 can be restricted to only transmitter devices that transmit single-carrier packet(s)). Alternatively or additionally, the signal 601 may be transmitted more seldom than the signal 600, or vice versa.

In some embodiments, the signal 601 is transmitted in association with connection establishment between the transmitter device 610 and the receiver 620. Alternatively or additionally, the signal 600 may be transmitted in response to reception of the signal 601, and/or when the OFDM signal structure changes.

In any case, the transmitter device 610 transmits one or more single-carrier packet(s) for reception by the receiver 620, as illustrated by the signal 602 (compare with step 470 of FIG. 4 and step 520 of FIG. 5).

Hence, the receiver 620 is configured to receive OFDM signal(s) from one or more transmitter devices (e.g., from OFDM transmitter device 630) as well as SC signal(s) from one of more (other) transmitter devices (e.g., from SC transmitter device 610).

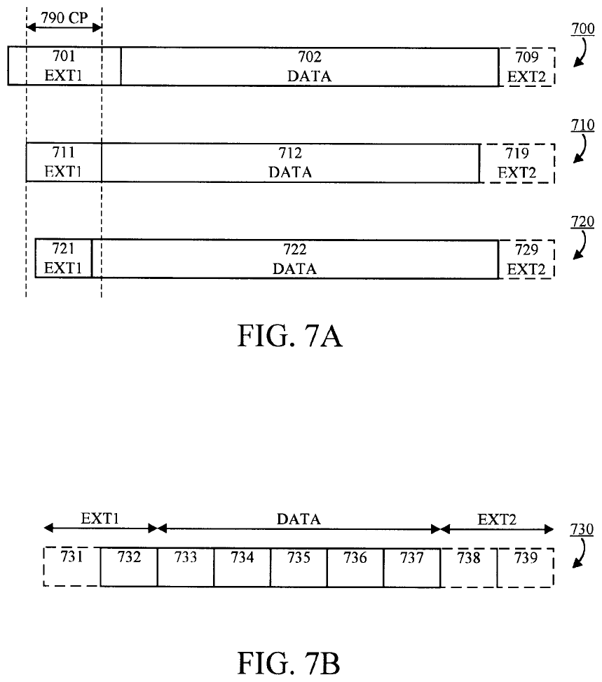

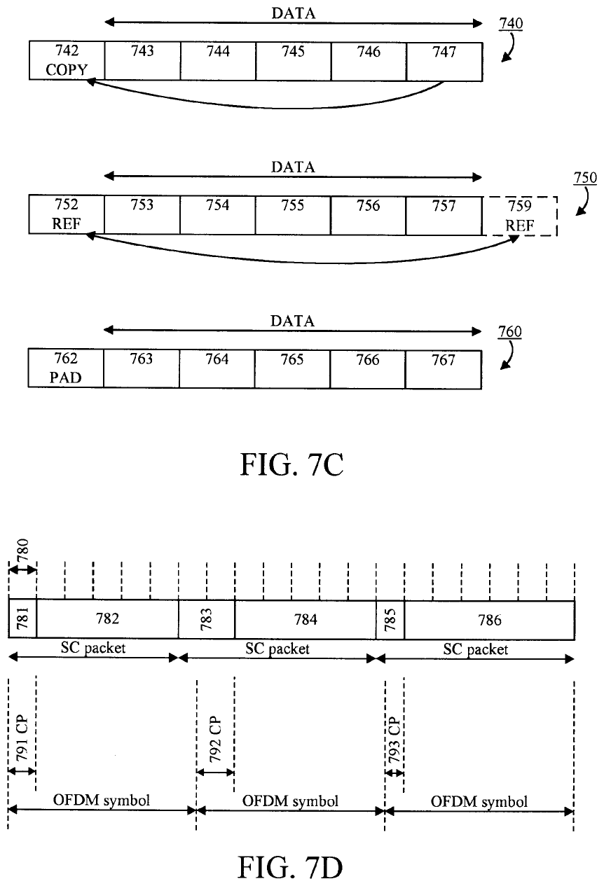

FIGS. 7A-D schematically illustrate example single-carrier packet formats according to some embodiments. For example, any one or more of the example single-carrier packet formats illustrated by FIG. 7A-D may correspond to the single-carrier packet(s) mention in connection with any of the FIGS. 4-6.

FIG. 7A illustrates a collection of single-carrier packets 700, 710, 720 according to some embodiments, wherein each single-carrier packet 700, 710, 720 has a respective data portion (DATA) 702, 712, 722, a first extension portion (EXT1) 701, 711, 721, and—optionally—a second extension portion (EXT2) 709, 719, 729.

As already elaborated on herein, the first extension portion 701, 711, 721 is prepended to the data portion 702, 712, 722 when the single-carrier packet 700, 710, 720 is generated, to cause that a time interval for transmission of the first extension portion overlaps, at least partially, with a time interval 790 for an OFDM signal cyclic prefix (CP).

In some embodiments, the time interval for transmission of the first extension portion comprises the time interval for OFDM signal cyclic prefix. This is exemplified by the single-carrier packet 700, where the time interval for transmission of the first extension portion 701 extends beyond the time interval 790 for OFDM signal cyclic prefix at both ends, and by the single-carrier packet 710, where the time interval for transmission of the first extension portion 711 is equal to the time interval 790 for OFDM signal cyclic prefix.

In some embodiments, the time interval for transmission of the first extension portion only partially comprises the time interval for OFDM signal cyclic prefix. This is exemplified by the single-carrier packet 720, where the time interval for transmission of the first extension portion 721 is comprised in the time interval 790 for OFDM signal cyclic prefix such that the time interval 790 for OFDM signal cyclic prefix extends beyond the time interval for transmission of the first extension portion 721 at both ends.

As already elaborated on herein, the second extension portion 709, 719, 729 is—when applicable—appended to the data portion 702, 712, 722 when the single-carrier packet 700, 710, 720 is generated. The length of the second extension portion 709, 719, 729 may be shorter than, equal to, or longer than the length of the first extension portion 701, 711, 721.

FIG. 7B illustrates a single-carrier packet 730 according to some embodiments, wherein single-carrier packet 730 comprises (e.g., consists of) packet sections 731-739 with equal duration. The single-carrier packet 730 has data portion (DATA) which comprises (e.g., consists of) a plurality of packet sections 733, 734, 735, 736, 737, a first extension portion (EXT1) which comprises (e.g., consist of) one or more packet sections 731, 732, and—optionally—a second extension portion (EXT2) which comprises (e.g., consist of) one or more packet sections 738, 739.

One way of aligning the plurality of packet sections 733, 734, 735, 736, 737 of the data portion with the OFDM symbol without CP comprises letting the duration of one packet section be T_{sym}/k, where T_{sym} is the duration of the OFDM symbol without CP (which is typically equal to 1/SCS), and k is number of packet sections of the data portion. This example is particularly relevant when no second extension portion is used.

FIG. 7C illustrates a collection of single-carrier packets 740, 750, 760 according to some embodiments.

The single-carrier packet 740 has a data portion (DATA) which consists of a plurality of packet sections 743, 744, 745, 746, 747, and a first extension portion which consists of one packet section 742. In this example, the first extension portion (i.e., the packet section 742) is a copy of a corresponding last part of the data portion (i.e., the packet section 747).

The single-carrier packet 750 has a data portion (DATA) which consists of a plurality of packet sections 753, 754, 755, 756, 757, and a first extension portion which consists of one packet section 752. In this example, the first extension portion (i.e., the packet section 752) is a reference portion (REF) with predetermined content. Optionally, the single-carrier packet 750 may have a second extension portion which consists of one packet section 759. For example, the second extension portion (i.e., the packet section 759) may be a copy of the first extension portion (i.e., the packet section 752).

The single-carrier packet 760 has a data portion (DATA) which consists of a plurality of packet sections 763, 764, 765, 766, 767, and a first extension portion which consists of one packet section 762. In this example, the first extension portion (i.e., the packet section 762) is a padding portion (PAD). The content of the padding portion may be any dummy content. For example, the padding portion may be an all-zero portion, an all-one portion, a random-content portion, or similar.

FIG. 7D illustrates an example sequence of single-carrier packets (SC packet) according to some embodiments. The sequence of single-carrier packets are generated using packet sections with equal duration 780. Each single-carrier packet comprises a respective data portion 782, 784, 786 which consists of a plurality of packet sections and a respective first extension portion 781, 783, 785 which consists of either one packet section (781, 785) or two packet sections (783).

The sequence of single-carrier packets is configured in relation to an OFDM signal structure that comprises a sequence of OFDM symbol occasions, each with a corresponding CP duration (i.e., a corresponding time interval for OFDM signal cyclic prefix) 791, 792, 793; possibly with varying length. Thus, a plurality of time intervals for OFDM signal cyclic prefix occurs during transmission of the sequence of single-carrier packets. To this end, each of the plurality of time intervals for OFDM signal cyclic prefix 791, 792, 793 during transmission of the sequence of single-carrier packets is overlapped, at least partially, by a respective first extension portion 781, 783, 785 of the sequence of single-carrier packets.

For example, if the data portions 782, 784, 786 of the single-carrier packets have a fixed length and (exemplified by five packet sections in FIG. 7D), a variable length of the first extension portion (exemplified by one/two packet sections in FIG. 7D), may be used to accommodate the sequence of single-carrier packets within the OFDM signal structure by selecting the length of the first extension portion based on the time interval for OFDM signal cyclic prefix to provide the, at least partial, overlap.

The following example further illustrates how fixed length data portions may be accommodated within an OFDM signal structure with varying CP duration.

The example refers to a NR OFDM system with 15 kHz numerology and an FFT size of 2048. During 0.5 ms, there are 7 OFDM symbols with a total of 15360 samples. The first CP has a duration corresponding to 160 samples and, the other six CPs each has a duration corresponding to 144 samples. Thus, the CP sample numbers are [1-160, 2209-2352, 4401-4544, 6593-6736, 8785-8928, 10977-11120, 13169-13312]. This pattern is repeated every 0.5 ms.

If a single-carrier packet approach is assumed with 80 samples per equal-duration packet section, the 15360 samples correspond to 192 packet sections, and CP samples appears in packet sections [1-2, 28-30, 56-57, 83-85, 110-112, 138-139, 165-167].

Thus, it is possible to completely overlap the time intervals for OFDM signal cyclic prefix by first extension portions with a duration which is variable between two and three packet sections if the packet section indices for first extension portions are selected as [1-2, 28-30, 56-57, 83-85, 110-112, 138-139, 165-167]. This may be achieved, for example, if the number of packet sections for the data portions is variable between 25 and 26, or if the number of packet sections for the data portions is fixed to 25 and a second extension portion of one packet section is used for all but the fourth and seventh single-carrier packet.

Alternatively, it is possible to completely overlap the time intervals for OFDM signal cyclic prefix by first extension portions with a duration which is fixed to three packet sections if the packet section indices for first extension portions are selected as [1-3, 28-30, 55-57, 83-85, 110-112, 138-140, 165-167]. This may be achieved, for example, if the number of packet sections for the data portions is variable between 25 and 26, or if the number of packet sections for the data portions is fixed to 25 and a second extension portion of one packet section is used for the third and fifth single-carrier packet.

Generally, one way of providing packet sections with equal duration that are suitable for OFDM signal structures with varying CP duration is to let the number of samples per packet section be equal to the greatest common factor (GCF) of the FFT size and the number of samples in each occurring CP duration, or a multiple thereof. This may be expressed as letting the number of samples per packet section be equal to the GCF scaled by an integer scaling factor which is greater than, or equal to, one.

Using the example above, the FFT size is 2048 and the number of samples in a CP duration is either 160 or 144. Since GCF(2048,160,144)=16, the number of samples per packet section could be equal to 16, or a multiple thereof.

Suitable multiples include those that result in that an integer number of packet sections fit precisely within one repetition of the OFDM signal structure. Using the example above, suitable multiples include any factor of 15360/16=960; i.e., [1, 2, 3, 4, 5, 6, 8, 10, 12, 15, 16, 20, 24, 30, 32, 40, 48, 60, 64, 80, 96, 120, 160, 192, 240, 320, 480, 960], and the factor 5 was used as integer scaling factor for the GCF 16 to provide packet sections with 80 samples each.

Thus, according to some embodiments, the equal duration of the packet sections may be determined by selecting an integer scaling factor for a greatest common factor (GCF) of a fast Fourier transform size of the receiver and a number of samples in an OFDM signal cyclic prefix (e.g., the number of samples in each occurring CP duration), and letting a number of samples of each of the packet sections correspond to the selected integer scaling factor multiplied by the GCF.

There is a tradeoff that can be considered when selecting the integer scaling factor for the GCF.

A comparatively low integer scaling factor yields a comparatively small number of samples per packet section. Thereby, there is more flexibility for selecting the duration of the extension portions. For example, the extension portions may be more tightly fitted to the CP durations which means that more resources is available for data (i.e., beneficial for throughput).

A comparatively high integer scaling factor yields a comparatively large number of samples per packet section. Thereby, there may be (relatively many) reference samples available after CP removal, which can be utilized for synchronization and/or SC detection. Alternatively or additionally, a comparatively large number of samples per packet section may be advantageous because a relatively low sampling rate may be used (which may lower the power consumption at the transmitter) and/or because equalization at the receiver may employ a relatively low complexity. Furthermore, inter-symbol interference may be increasingly difficult to handle as the number of samples per packet section decreases.

It should be noted that-additionally or alternatively-packet sections with equal duration that are suitable for OFDM signal structures with varying CP duration may be provided by letting the number of samples per packet section be equal to any suitable integer factor of the greatest common factor (GCF) of the FFT size and the number of samples in each occurring CP duration.

Using the example above, GCF(2048,160,144)=16, so the number of samples per packet section could be equal to 1, 2, 4, or 8.

Thus, according to some embodiments, the equal duration of the packet sections may be determined by selecting an integer factor of the GCF, and letting a number of samples of each of the packet sections correspond to the selected integer factor of the GCF.

In practice, it is often beneficial to have a relatively high number of samples per packet section. It should be noted that FIGS. 7A-D illustrate different features of single-carrier packets, and that the different features of FIGS. 7A-D are typically combined to form a single-carrier packet. For example, the structure of packet sections with equal duration as illustrated in FIG. 7B may be combined with one of the relations between the CP length and the time interval for transmission of the first extension portion as illustrated in FIG. 7A and with one of the alternative contents of the first extension portion as illustrated in FIG. 7C, to form a single-carrier packet suitable for the sequence as illustrated in FIG. 7D.

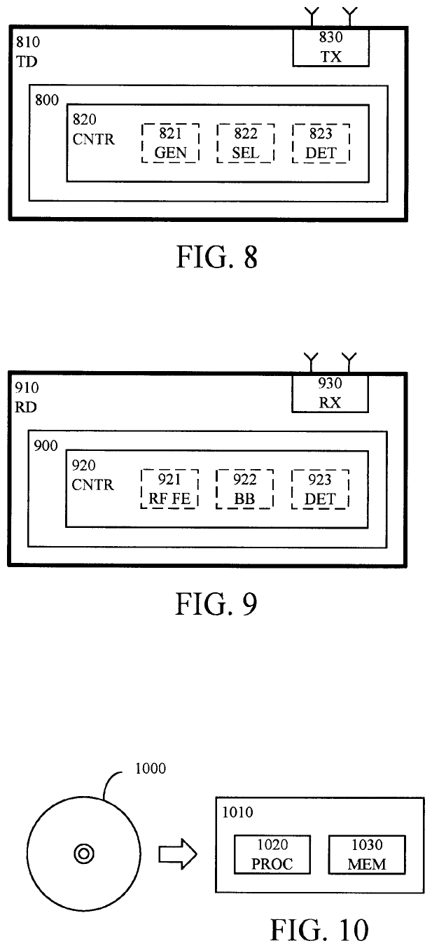

FIG. 8 schematically illustrates an example apparatus 800 according to some embodiments. The apparatus 800 is for generating a single-carrier packet using packet sections with equal duration for transmission to a receiver configured to receive an orthogonal frequency division multiplex (OFDM) signal.

The single-carrier packet may, for example, correspond to one or more of the single-carrier packet formats exemplified in FIGS. 7A-D.

The apparatus 800 may be comprised, or comprisable, in a single-carrier transmission device (TD; e.g., a user equipment, UE) 810. For example, the single-carrier transmission device may be a transmitter device with power consumption restrictions (e.g., powered by a non-chargeable power source, powered by energy harvesting, and/or an ultra-low power device).

Alternatively or additionally, the apparatus 800 may be configured to perform (or cause performance of) one or more steps of the method 400 of FIG. 4.

The apparatus 800 comprises a controller (CNTR; e.g., controlling circuitry or a control module) 820.

The controller 820 is configured to cause establishment of a data portion of the single-carrier packet, wherein the data portion comprises a plurality of packet sections (compare with step 430 of FIG. 4).

The controller 820 is also configured to cause prepending of a first extension portion to the data portion, wherein the first extension portion comprises one or more packet sections, and wherein a time interval for transmission of the first extension portion overlaps, at least partially, with a time interval for OFDM signal cyclic prefix (compare with step 450 of FIG. 4).

In some embodiments, the controller 820 is also configured to cause appending of a second extension portion to the data portion (compare with step 460 of FIG. 4).

To this end, the controller 820 may comprise, or be otherwise associated with (e.g., connected, or connectable, to) a packet generator (GEN; e.g., generating circuitry or a generation module) 821. The packet generator 821 may be configured to establish the data portion, prepend the first extension portion, and—optionally—append the second extension portion.

The controller 820 may also be configured to cause selection of the length of the first extension portion and/or the length of the second extension portion; when applicable (compare withe step 440 of FIG. 4).

To this end, the controller 820 may comprise, or be otherwise associated with (e.g., connected, or connectable, to) a selector (SEL; e.g., selecting circuitry or a selection module) 822. The selector 822 may be configured to select the length of the first and/or second extension portion(s).

The controller 820 may also be configured to cause determination of the time interval for OFDM signal cyclic prefix (compare with step 420 of FIG. 4).

To this end, the controller 820 may comprise, or be otherwise associated with (e.g., connected, or connectable, to) a determiner (DET; e.g., determining circuitry or a determination module) 823. The determiner 823 may be configured to determine the time interval for OFDM signal cyclic prefix.

The controller 820 may also be configured to cause transmission of the single-carrier packet (compare with step 470 of FIG. 4).

The controller 820 may also be configured to cause indication of single-carrier packet transmission to the receiver; e.g., by transmission of an explicit indication to the receiver in association with connection establishment (compare with step 410 of FIG. 4) and/or by transmission of the single-carrier packet in communication resources specifically dedicated for single-carrier transmission (compare with step 470 of FIG. 4).

To this end, the controller 820 may comprise, or be otherwise associated with (e.g., connected, or connectable, to) a transmitter (TX; e.g., transmitting circuitry or a transmission module) 830. The transmitter 830 may be configured to transmit the generated single-carrier packet(s) and/or the explicit indication.

FIG. 9 schematically illustrates an example apparatus 900 according to some embodiments. The apparatus 900 is for processing a received signal by a receiver configured to receive an orthogonal frequency division multiplex (OFDM) signal.

The apparatus 900 may be comprised, or comprisable, in a receiver device (RD; e.g., a user equipment, UE, or a base station, BS) 910.

Alternatively or additionally, the apparatus 900 may be configured to perform (or cause performance of) one or more steps of the method 500 of FIG. 5.

The apparatus 900 comprises a controller (CNTR; e.g., controlling circuitry or a control module) 920.

The controller 920 may comprise, or be otherwise associated with (e.g., connected, or connectable, to) a receiver (RX; e.g., receiving circuitry or a reception module) 930. The receiver 930 may be configured to receive the signal (compare with step 520 of FIG. 5).

The apparatus 900 comprises a controller (CNTR; e.g., controlling circuitry or a control module) 920.

The controller 920 is configured to cause discarding of a part of the received signal that corresponds to the length of an OFDM signal cyclic prefix (compare with step 530 of FIG. 5), application of a fast Fourier transform to the received signal (compare with step 540 of FIG. 5), and provision of a baseband representation of the received signal based on a result of the fast Fourier transform (compare with step 550 of FIG. 5).

To this end, the controller 920 may comprise, or be otherwise associated with (e.g., connected, or connectable, to) a radio frequency front (RF FE; e.g., front end circuitry or a front end module) 921. The radio frequency front end 921 may be configured to discard a part of the received signal that corresponds to the length of an OFDM signal cyclic prefix, apply a fast Fourier transform to the received signal, and provide a baseband representation of the received signal based on a result of the fast Fourier transform.

The controller 920 is also configured to cause processing of the baseband representation of the received signal as a single-carrier packet generated using packet sections with equal duration (compare with step 580 of FIG. 5).

To this end, the controller 920 may comprise, or be otherwise associated with (e.g., connected, or connectable, to) a baseband processor (BB; e.g., baseband processing circuitry or a baseband processing module) 922. The baseband processor 922 may be configured to process the baseband representation of the received signal as a single-carrier packet generated using packet sections with equal duration.

The controller 920 may also be configured to cause determination of whether or not the received signal comprises single-carrier packet transmission (compare with step 590 of FIG. 5).

To this end, the controller 920 may comprise, or be otherwise associated with (e.g., connected, or connectable, to) a determiner (DET; e.g., determining circuitry or a determination module) 923. The determiner 923 may be configured to determine whether or not the received signal comprises single-carrier packet transmission.

As elaborated on earlier, determination that the received signal comprises single-carrier packet transmission may comprise reception of an explicit indication of single-carrier packet transmission in association with connection establishment (compare with step 510 of FIG. 5), and/or reception of the signal in communication resources specifically dedicated for single-carrier transmission (compare with step 520 of FIG. 5), and/or detection of a reference portion in the received signal, wherein the reference portion is indicative of single-carrier packet transmission (compare with step 560 of FIG. 5).

Processing of the baseband representation of the received signal as a single-carrier packet may be responsive to determination that the received signal comprises single-carrier packet transmission. Determination the received signal does not comprise single-carrier packet transmission may cause processing of the baseband representation of the received signal as an OFDM signal (compare with step 590 of FIG. 5).

Generally, any feature or advantage described herein in connection with one Figure or embodiment should be understood as equally applicable (when suitable; mutatis mutandis) for any other Figure or embodiment, even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication device.

Embodiments may appear within an electronic apparatus (such as a communication device) comprising arrangements, circuitry, and/or logic according to any of the embodiments described herein. Alternatively or additionally, an electronic apparatus (such as a communication device) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 10 illustrates an example computer readable medium in the form of a compact disc (CD) ROM 1000. The computer readable medium has stored thereon a computer program comprising program instructions. The computer program is loadable into a data processor (PROC; e.g., a data processing unit) 1020, which may, for example, be comprised in a communication device 1010. When loaded into the data processor, the computer program may be stored in a memory (MEM) 1030 associated with, or comprised in, the data processor. According to some embodiments, the computer program may, when loaded into, and run by, the data processor, cause execution of method steps according to, for example, any of the methods illustrated in FIGS. 4 and 5, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method of generating a single-carrier packet using packet sections with equal duration for transmission to a receiver configured to receive an orthogonal frequency division multiplex (OFDM) signal with a first OFDM symbol having a first cyclic prefix duration and a second OFDM symbol having a second cyclic prefix duration, the first cyclic prefix duration having a different size than the second cyclic prefix duration, the method comprising:
establishing a data portion of the single-carrier packet, the data portion comprising a plurality of packet sections;
prepending a first extension portion to the data portion, the first extension portion comprising one or more packet sections, and a time interval for transmission of the first extension portion overlapping, at least partially, with a time interval for the first cyclic prefix; and
a number of samples of a packet section corresponds to:
a greatest common factor (GCF) of:
a fast Fourier transform size of the receiver; and
a number of samples in the first cyclic prefix duration; and
a number of samples in the second cyclic prefix duration multiplied by an integer scaling factor which is greater than or equal to one; or a number of samples of a packet section corresponds to:
an integer factor of the GFC multiplied by an integer scaling factor which is greater than or equal to one, the integer factor being greater than one.

2. The method of claim 1, wherein the single-carrier packet is comprised in a sequence of single-carrier packets generated using packet sections with equal duration, wherein a plurality of time intervals for OFDM signal cyclic prefix occurs during transmission of the sequence of single-carrier packets, and wherein each of the plurality of time intervals for OFDM signal cyclic prefix during transmission of the sequence of single-carrier packets is overlapped, at least partially, by a respective first extension portion of the sequence of single-carrier packets.

3. The method of claim 1, further comprising determining the time interval for OFDM signal cyclic prefix.

4. The method of claim 1, wherein the time interval for transmission of the first extension portion comprises the time interval for the first cyclic prefix.

5. The method of claim 1, wherein the time interval for transmission of the first extension portion and the time interval for the first cyclic prefix are equal.

6. The method of claim 1, wherein the first extension portion comprises a copy of a corresponding last part of the data portion.

7. The method of claim 1, wherein the first extension portion comprises a reference portion with predetermined content.

8. (canceled)

9. The method of claim 1, wherein the first extension portion comprises a padding portion.

10. The method of claim 1, further comprising indicating single-carrier packet transmission to the receiver.

11. The method of claim 10, wherein indicating single-carrier packet transmission comprises one or more of:
transmitting an explicit indication to the receiver in association with connection establishment; and
transmitting the single-carrier packet in communication resources specifically dedicated for single-carrier transmission.

12. The method of claim 1, wherein the data portion of the single-carrier packet has a fixed length and a length of the first extension portion is variable, the method further comprising:
selecting the length of the first extension portion based on the time interval for the first cyclic prefix to provide the, at least partial, overlap.

13. (canceled)

14. (canceled)

15. The method of claim 1, wherein the packet sections with equal duration specify a constant baud rate.

16. A method of processing a received signal by a receiver configured to receive an orthogonal frequency division multiplex (OFDM) signal, the method comprising:
applying a fast Fourier transform to the received signal after discarding a part of the received signal that corresponds to a length of an OFDM signal cyclic prefix;
providing a baseband representation of the received signal based on a result of the fast Fourier transform; and
processing the baseband representation of the received signal as a single-carrier packet generated using packet sections with equal duration.

17. The method of claim 16, further comprising determining that the received signal comprises single-carrier packet transmission, and wherein processing the baseband representation of the received signal as a single-carrier packet is responsive to the determination.

18. The method of claim 17, wherein determining that the received signal comprises single-carrier packet transmission comprises one or more of:
receiving an explicit indication of single-carrier packet transmission in association with connection establishment;
receiving the signal in communication resources specifically dedicated for single-carrier transmission; and
detecting a reference portion in the received signal, wherein the reference portion is indicative of single-carrier packet transmission.

19. (canceled)

20. An apparatus for generating a single-carrier packet using packet sections with equal duration for transmission to a receiver configured to receive an orthogonal frequency division multiplex (OFDM) signal with a first OFDM symbol having a first cyclic prefix duration and a second OFDM symbol having a second cyclic prefix duration, the first cyclic prefix duration having a different size than the second cyclic prefix duration, the apparatus comprising controlling circuitry configured to cause:
establishment of a data portion of the single-carrier packet, the data portion comprising a plurality of packet sections; and
prepending of a first extension portion to the data portion, the first extension portion comprising one or more packet sections, and a time interval for transmission of the first extension portion overlapping, at least partially, with a time interval for the first cyclic prefix; and
a number of samples of a packet section corresponds to:
a greatest common factor (GCF) of:
a fast Fourier transform size of the receiver; and
a number of samples in the first cyclic prefix duration; and
a number of samples in the second cyclic prefix duration multiplied by an integer scaling factor which is greater than or equal to one; or
a number of samples of a packet section corresponds to:
an integer factor of the GFC multiplied by an integer scaling factor which is greater than or equal to one, the integer factor being greater than one.

21. The apparatus of claim 20, wherein the single-carrier packet is comprised in a sequence of single-carrier packets generated using packet sections with equal duration, wherein a plurality of time intervals for OFDM signal cyclic prefix occurs during transmission of the sequence of single-carrier packets, and wherein each of the plurality of time intervals for OFDM signal cyclic prefix during transmission of the sequence of single-carrier packets is overlapped, at least partially, by a respective first extension portion of the sequence of single-carrier packets.

22-35. (canceled)

36. An apparatus for processing a received signal by a receiver configured to receive an orthogonal frequency division multiplex (OFDM) signal, the apparatus comprising controlling circuitry configured to cause:
application of a fast Fourier transform to the received signal after discarding of a part of the received signal that corresponds to a length of an OFDM signal cyclic prefix;
provision of a baseband representation of the received signal based on a result of the fast Fourier transform; and
processing of the baseband representation of the received signal as a single-carrier packet generated using packet sections with equal duration.

37-41. (canceled)

42. The method of claim 16, wherein the OFDM signal includes a first OFDM symbol having a first cyclic prefix duration and a second OFDM symbol having a second cyclic prefix duration, wherein the first cyclic prefix duration has a different size than the second cyclic prefix duration; and
wherein a number of samples of a packet section corresponds to:
a greatest common factor (GCF) of:
a fast Fourier transform size of the receiver; and
a number of samples in the first cyclic prefix duration; and
a number of samples in the second cyclic prefix duration, multiplied by an integer scaling factor which is greater than or equal to one; or
wherein a number of samples of a packet section corresponds to:
an integer factor of the GFC multiplied by an integer scaling factor which is greater than or equal to one, wherein the integer factor is greater than one.

43. The apparatus of claim 36, wherein the OFDM signal includes a first OFDM symbol having a first cyclic prefix duration and a second OFDM symbol having a second cyclic prefix duration, wherein the first cyclic prefix duration has a different size than the second cyclic prefix duration; and
wherein a number of samples of a packet section corresponds to:
a greatest common factor (GCF) of:
a fast Fourier transform size of the receiver; and
a number of samples in the first cyclic prefix duration; and
a number of samples in the second cyclic prefix duration, multiplied by an integer scaling factor which is greater than or equal to one; or
wherein a number of samples of a packet section corresponds to:
an integer factor of the GFC multiplied by an integer scaling factor which is greater than or equal to one, wherein the integer factor is greater than one.
